(19) United States
(12) Patent Application Publication
(10) Pub. No.: US 2018/0017006 A1
(43) Pub. Date: Jan. 18, 2018

(54) METHOD OF DETECTING ENGINE TUNING OF VEHICLE

(71) Applicant: Hyundai Motor Company, Seoul (KR)

(72) Inventor: Pan Sang KIM, Seoul (KR)

(73) Assignee: Hyundai Motor Company, Seoul (KR)

(21) Appl. No.: 15/354,847

(22) Filed: Nov. 17, 2016

(30) Foreign Application Priority Data
Jul. 15, 2016 (KR) 10-2016-0089612

(51) Int. Cl. F02D 41/24; F02D 41/12; F02D 35/02; F02D 41/14; F02D 41/00

(52) U.S. Cl. CPC F02D 41/2438; F02D 41/1498; F02D 41/0007; F02D 35/027; F02D 41/12; F02D 2200/0406; F02D 2200/602

(57) ABSTRACT

A method of detecting illegal tuning of the vehicle may include obtaining and storing, by a controller, at least one of learning information including a variable value and a control value and engine state information at a time of controlling the vehicle while the vehicle is driven, as a learning value; comparing, by the controller, a learning value, which is newly obtained over time, with a prestored previous learning value; determining, by the controller, that a tuning chip for changing component performance in the vehicle is mounted when the learning value is changed and there remains a difference between the obtained learning value and the prestored previous learning value at a predetermined level or higher for a predetermined period of time; and creating and storing, by the controller, a tuning detection code when it is determined that the tuning chip is mounted.

### CROSS-REFERENCE TO RELATED APPLICATION

The present application claims priority to Korean Patent Application No. 10-2016-0089612 filed on Jul. 15, 2016, the entire contents of which is incorporated herein for all purposes by this reference.

### BACKGROUND OF THE INVENTION

### Field of the Invention

The present invention relates to a method of detecting engine tuning of a vehicle. More particularly, it relates to a method capable of detecting whether an external tuning chip is mounted in a turbocharged vehicle in order to increase engine output.

### Description of Related Art

Recently, a turbocharger, which supercharges a combustion chamber with high-pressure air, an intercooler, and the like are additionally mounted in a high-performance engine in order to obtain high output.

The turbocharger is an apparatus that compresses air by using energy of exhaust gas and supplies the compressed air into the combustion chamber of the engine. The combustion chamber of the engine equipped with the turbocharger may be charged with a large amount of air, and as a result, it is possible to increase the injection amount of fuel in proportion to the amount of air increased under a supercharged condition.

As a result, the engine equipped with the turbocharger can obtain higher output than a naturally aspirated engine having a combustion chamber with the same volume.

Typically, the engine equipped with the turbocharger is called a turbo engine. An electronic control method has been known which detects the pressure of air being supplied into the combustion chamber from the turbocharger through an intake manifold, and controls pressure of air flowing along the interior of the intake manifold within an appropriate range.

The turbocharger includes a turbine which converts energy of exhaust gas into mechanical work by being rotated by the exhaust gas, and a compressor which is coaxially connected with the turbine and compresses air while rotating. In this case, the turbine is disposed in an exhaust path in the engine, and the compressor is disposed in an intake path in the engine.

Therefore, when the turbine is rotated by exhaust gas, the compressor is rotated together with the turbine, and the rotating compressor sucks and compresses rotating air, and then supplies the compressed air into an intake side of the engine. In this case, the supercharging air compressed by the compressor is cooled while passing through the intercooler, and then supplied into the intake side and the combustion chamber of the engine.

Meanwhile, recently, drivers are not satisfied with engine output and performance of a vehicle, and thus many drivers often illegally tune the vehicle in order to enable the engine to exhibit high output and high performance.

For example, to increase engine output to the output higher than durability guaranteeing output determined by vehicle manufacturers, the drivers illegally mount external tuning chips (e.g., an ‘UNCLE chip’ manufactured by LAB3) in the engine in a tuning shop. As an example, a tuning chip has been known which is manufactured to change signals from a manifold absolute pressure (MAP) sensor for detecting the amount of air in the engine and a boost pressure (pressure up throttle, PUT) sensor, and output the changed signals.

For reference, the MAP sensor is a sensor which detects pressure in the intake manifold, and the boost pressure sensor is a sensor which detects boost pressure of intake air flowing along the interior of the intake manifold in an electronic turbocharged engine, and outputs electrical signals depending on the pressure.

The tuning chip may be used by being simply connected between the sensors and an ECU through cables, and as a result, recently, the tuning chips tend to be frequently mounted. Unlike a normal vehicle which is not tuned, where an ECU 10, as illustrated in FIG. 1, receives signals directly from a MAP sensor 1 and a boost pressure sensor 2, in a vehicle equipped with a tuning chip 3, the tuning chip 3 changes signals from the MAP sensor 1 and the boost pressure sensor 2, and the ECU 10 receives the changed signals as illustrated in FIG. 2.

In a case in which the tuning chip 3 is mounted, the ECU 10 receives a changed signal that indicates the amount of air larger than the actual amount of air detected by the sensor, or receives a changed signal that indicates boost pressure at a low level even in a case in which there is actually high boost pressure. Therefore, the ECU recognizes the amount of air larger than the actual amount of air based on the changed signal, and thus controls the amount of fuel so as to inject a larger amount of fuel in accordance with the increased amount of air.

The ECU recognizes boost pressure lower than actual boost pressure, and thus increases the amount of air inflow in order to increase boost pressure, and advances ignition timing. Therefore, compared to before tuning, an effect of temporarily increasing acceleration may be obtained due to an increase in boost pressure when an accelerator pedal is equally operated, and as a result, the engine may exhibit high output and high performance.

However, in a case in which the tuning chip is used, engine output may be increased over durability guaranteeing output, so that the engine may be overloaded, and durability of the engine may be adversely affected. In addition, there occurs a problem such as excessive boost pressure, excessive knocking, and abnormal combustion.

Various types of control such as control of the amount of fuel, and turbo control may be unstably performed, and a problem of damage to the engine such as damage to the turbocharger, the intercooler, and an intake system, and breakage of an ignition plug and components of the combustion chamber may occur due to an excessive increase in pressure.

As a result, repairing costs are incurred because the driver needs to take his/her vehicle to a service center and have the vehicle repaired, and the automobile manufacturer is also burdened with after sales services because the automobile manufacture needs to repair the engine damaged by the illegally mounted tuning chip.

In particular, because an external tuning chip may be simply mounted by using a swap cable without damaging wiring in the vehicle, the driver often detaches the illegal chip and then takes the engine in for repair, but the automobile manufacturer cannot secure proof that the tuning chip was mounted, and as a result, the automobile manufacture inevitably repairs the vehicle free of charge under warranty.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method configured for detecting whether an illegal tuning chip is mounted and used in a vehicle and storing a use history of the tuning chip because an automobile manufacturer needs to know whether a driver has actually tuned the vehicle and whether a driver has mounted and used the tuning chip in order to induce the driver not to mount an illegal tuning chip and induce the driver to detach the illegal tuning chip by himself/herself.

In one aspect, the present invention provides a method of detecting tuning of the vehicle, the method including: obtaining and storing, by a controller, at least one of learning information including a variable value and a control value and engine state information at a time of controlling the vehicle while the vehicle is driven, as a learning value; comparing, by the controller, a learning value, which is newly obtained over time, with the prestored previous learning value; determining, by the controller, that a tuning chip for changing component performance in the vehicle is mounted when the learning value is changed and there remains a difference between the obtained learning value and the prestored previous learning value at a predetermined level or higher for a predetermined period of time; and creating and storing, by the controller, a tuning detection code when it is determined that the tuning chip is mounted.

Therefore, the method of detecting illegal tuning of the vehicle according to an exemplary embodiment of the present invention detects whether an external tuning chip for increasing engine output is mounted and used based on a control learning value while a turbocharged vehicle is driven, and stores use information, and as a result, it is possible to induce a driver to detach an illegal tuning chip by himself/herself, and induce the driver not to mount an illegal tuning chip.

Because it is possible to prevent damage to the engine and the incurrence of repairing costs caused by illegal tuning, and it is possible to solve a problem that the automobile manufacture bears the responsibility for the illegal tuning by the driver.

Other aspects and preferred embodiments of the invention are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuel derived from resources other than petroleum). As referred to herein, a hybrid vehicle is a vehicle that has two or more sources of power, for example both gasoline-powered and electric-powered vehicles.

The above and other features of the invention are discussed infra.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram illustrating a connection state between sensors and an ECU in a normal vehicle that is not tuned;

FIG. 2 is a block diagram illustrating a connection state between sensors and an ECU in a vehicle equipped with an external tuning chip;

FIG. 3 is a block diagram illustrating a configuration of a tuning detecting apparatus according to an exemplary embodiment of the present invention; and

FIG. 4 is a flowchart illustrating a tuning detecting method according to an exemplary embodiment of the present invention.

Reference numerals set forth in the Drawings include reference to the following elements as further discussed below:

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) may be intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described in detail with reference to the accompanying drawings so that those skilled in the art to which the present invention pertains may easily carry out the exemplary embodiments. However, the present invention is not limited to the exemplary embodiments to be described below and may be specified as other aspects.

Unless otherwise described, throughout the specification, the word “comprise” and variations such as “comprises” or “comprising” will be understood to imply the inclusion of stated elements, not the exclusion of any other elements.

FIG. 3 is a block diagram illustrating a configuration of a tuning detecting apparatus according to an exemplary embodiment of the present invention.

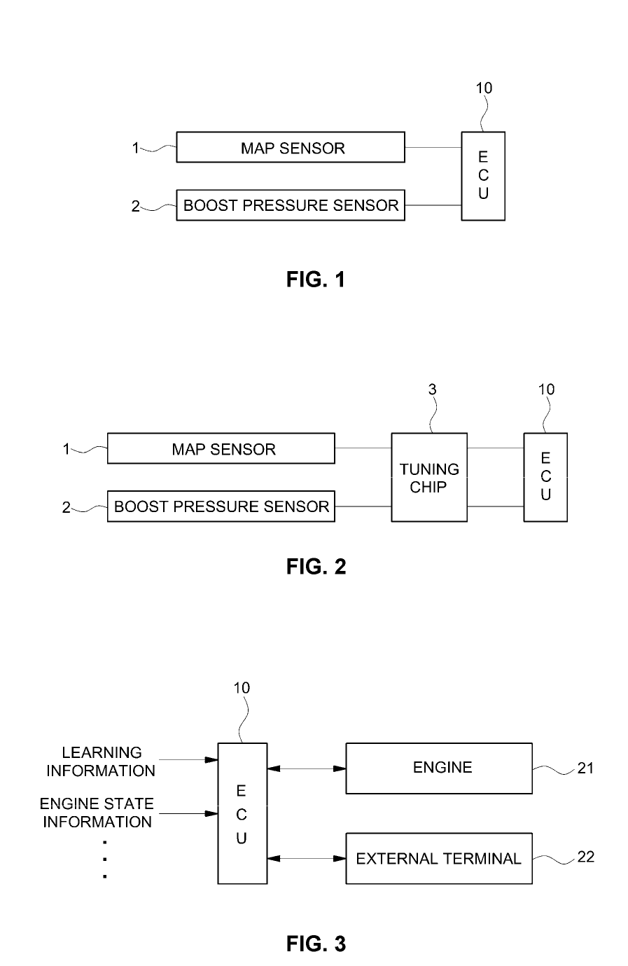

A connection state between sensors 1 and 2 and a control unit (ECU) 10 in a normal vehicle which is not tuned and in an illegally tuned vehicle equipped with an external tuning chip 3 for changing performance will be described with reference to FIG. 1 and FIG. 2.

The present invention relates to a method of detecting tuning of the vehicle, and the present invention is characterized in that the controller 10 detects whether a tuning chip for changing component performance, for example, an illegal external tuning chip (designated by reference numeral 3 in FIG. 2) for increasing engine output is mounted and used in the vehicle, based on learning information and engine state information obtained while the vehicle is driven, and when it is detected that the external tuning chip is mounted, the controller 10 generates and stores a tuning code to remain as a use history.

To this end, the controller 10 is configured to determine whether the tuning chip is mounted through predetermined diagnosis logic that obtains learning information including a variable value or a control value and engine state information including knocking and misfire at a time of controlling the vehicle, for example, controlling a turbocharger and an engine while the vehicle is driven, and analyzes the obtained learning information and engine state information.

First, in the vehicle equipped with the turbocharger, that is, the turbocharged vehicle, the controller 10 stores, as a learning value, at least one information of the learning information including the variable value or the control value and the engine state information including knocking and misfire, which are obtained at the time of controlling the turbocharger and the engine while the vehicle is driven.

In this case, the controller 10 stores the predetermined number of learning values with a predetermined time period, obtained from a new vehicle state after purchase of the vehicle, and stores and ensures the predetermined number of data in a memory by deleting the oldest data one by one each time new data is obtained one by one during a process in which predetermined data is periodically obtained and accumulated at the time of controlling the turbocharger.

The turbocharger control learning values are assuredly different between a case in which no tuning chip is mounted and a case in which the tuning chip is mounted under a same engine operating condition, and the learning value at the time of controlling the turbocharger may be sensor information obtained together with a signal value of an Accel Position Sensor (APS) which is a sensor for detecting a position of an accelerator pedal (an operation degree of an accelerator pedal) by a driver, and more, a signal value of the MAP sensor 1 or a signal value of the boost pressure sensor 2 which is obtained together with the APS signal value.

The learning value is continuously obtained while the vehicle is driven even after the external tuning chip (designated by reference numeral 3 in FIG. 2) is illegally mounted in the engine 21 as illustrated in FIG. 2 as well as in a state in which no external tuning chip is mounted as illustrated in FIG. 1.

The MAP sensor 1 and the boost pressure sensor 2 output electrical signals corresponding to a detected pressure value, and the signals outputted from the sensors 1 and 2 are directly inputted to the controller 10 in a case in which no tuning chip 3 is mounted, but in a case in which the tuning chip 3 is mounted, a sensor signal changed by the tuning chip 3 is inputted to the controller 10.

The tuning chip 3 changes the signals (electrical signals indicating pressure) outputted from the MAP sensor 1 and the boost pressure sensor 2 into a signal that indicates a pressure value lower than an actual pressure value, and outputs the signal, and when the changed sensor signal is inputted to the controller 10, the controller 10 receives a signal, which indicates pressure lower than actual pressure, from the sensors 1 and 2 as pressure variable information for controlling the engine 21.

Therefore, it is possible to determine whether the tuning chip is mounted by comparing the sensor signal (the signal inputted directly from the sensor) before the tuning chip is mounted with the sensor signal (the signal changed by the tuning chip) after the tuning chip is mounted.

Therefore, in an exemplary embodiment of the present invention, the controller 10 stores the signal value of the MAP sensor 1 and the signal value of the boost pressure sensor 2 as the learning values while the vehicle is driven, and determines whether the tuning chip is mounted by comparing the learning values in a case in which the APS signal values are the same, that is, comparing the signal values of the MAP sensor, which are stored and learned as described above, or comparing the signal values of the boost pressure sensor.

In this case, the controller 10 may use the signal value of one of the two sensors 1 and 2 or the signal values of both of the two sensors 1 and 2, and the controller 10 may be configured to compare the respective learning values (the signal value of the MAP sensor, or the signal value of the boost pressure sensor, or the signal value of the MAP sensor and the signal value of the boost pressure sensor) with the previous learning values when the same APS signal value is inputted, and determine that the tuning chip 3 is mounted when the signal value variation amount of the same sensor is at a predetermined level or higher for a predetermined period of time, as described below.

As illustrated in FIG. 2, in a case in which the tuning chip 3 is mounted, turbocharger pressure (pressure at an outlet end of a compressor), that is, boost pressure is increased at the time of controlling the turbocharger, and therefore, the amount of air supplied to the engine intake side is also increased, and the amount of fuel injected into the combustion chamber of the engine 21 is also increased when the amount of air is increased.

Therefore, the learning value at the time of controlling the turbocharger may include boost pressure information, or may be the APS signal value at the time of controlling the turbocharger and fuel amount information obtained together with the APS signal value.

The learning value, which is obtained through fuel amount learning as described above, is continuously obtained while the vehicle is driven even after the external tuning chip 3 is mounted in the engine 21 as illustrated in FIG. 2 as well as in a state in which no external tuning chip 3 is mounted as illustrated in FIG. 1.

In a state in which the tuning chip is mounted, the amount of air supplied to the engine 21 is increased at the time of controlling the turbo charger under a high-load condition compared to when no tuning chip is mounted, and as a result, the occurrence of a heavy knock is increased, and the occurrence of misfire in the engine 21 is also increased.

For example, in a case in which the tuning chip is mounted, the occurrence of misfire may be detected in all the cylinders (combustion chambers) of the engine 21, or the occurrence of misfire may be detected at the time of controlling the turbocharger under a high-load condition.

Therefore, the engine state information may be stored as the learning value in the controller 10 while the vehicle is driven, and may include knock intensity or knock occurrence frequency detected by a knock sensor, or engine misfire occurrence state or frequency.

That is, at least one of knock occurrence information and engine misfire occurrence information at the time of controlling the turbocharger may be included in the engine state information, and the controller 10 may be configured to determine that the tuning chip is mounted when the knock intensity or frequency is increased at the time of controlling the turbocharger while the vehicle is driven, and changed to a predetermined level or higher for a predetermined period of time compared to previous knock intensity or frequency.

The controller 10 may be configured to determine that the tuning chip is mounted when the occurrence of misfire is detected in all the cylinders of the engine 21 or when misfire occurrence frequency in the engine 21 is increased for a predetermined period of time and changed to a predetermined level or higher compared to the previous misfire occurrence frequency.

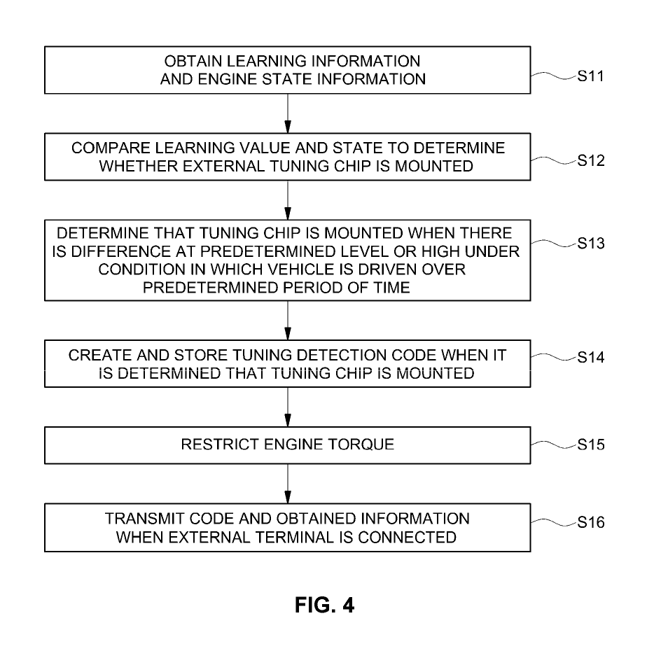

FIG. 4 is a flowchart illustrating a method of detecting tuning according to the exemplary embodiment of the present invention, and the method will be described in detail in a stepwise manner below with reference to FIG. 4.

First, at least one of the learning information including the variable value and the control value and the engine state information is obtained and stored as the learning value at the time of controlling the turbocharger while the vehicle is driven (S11).

Here, the variable value may be the sensor signal value together with the APS signal value, that is, the signal values of the MAP sensor or the boost pressure sensor, or signal values of the MAP sensor and the boost pressure sensor, and the control value may be boost pressure at the time of controlling the turbocharger, the amount of fuel (i.e., the amount of fuel injected into the engine) together with the APS signal value.

The engine state information may be the engine knock occurrence information (i.e., the knock intensity and the knock occurrence frequency), and the misfire occurrence information (i.e., the misfire occurrence state and the occurrence frequency).

Next, the controller 10 compares the learning value, which is newly obtained as time passed, with the prestored previous learning value (S12), and determines that the tuning chip is mounted when the learning value is changed and there remains a difference between the obtained learning value and the prestored previous learning value at a predetermined level or higher for a predetermined period of time (S13).

For example, it is determined that the tuning chip is mounted when the MAP sensor signal value is changed and different from the previous MAP sensor signal value by a predetermined level or higher in a case in which the APS signal values are the same, or the boost pressure sensor signal value is changed and different from the previous boost pressure sensor signal value by a predetermined level or higher.

In addition, it is determined that the tuning chip is mounted when the boost pressure is changed and different from the previous boost pressure by a predetermined level or higher, or the amount of fuel in a case in which the APS signal values are the same is changed and different from the previous amount of fuel by a predetermined level or higher, or the knock intensity or the knock occurrence frequency is increased to a predetermined level or higher compared to the previous knock intensity or the previous knock occurrence frequency, or misfire occurs in all the cylinders of the engine 21, or the misfire occurrence frequency of the engine 21 is increased to a predetermined level or higher compared to the previous misfire occurrence frequency.

Here, the predetermined level for each learning value is predetermined, and all the predetermined levels are predetermined to be different from each other for each learning value, and then prestored in the controller 10.

Next, when the controller 10 determines that the tuning chip is mounted as described above, the controller 10 immediately creates and stores a tuning detection code (S14).

When the controller 10 determines that the tuning chip is mounted, the controller 10 may be configured to subsequently restrict torque of the engine 21 so that the torque of the engine 21 is predetermined torque or lower while the vehicle is driven (S15).

Meanwhile, when the driver performs maintenance on the vehicle or takes the vehicle to a garage for repair, and an external terminal 22 for diagnosis is connected to the vehicle in the garage in a state after the tuning detection code has been stored in the controller 10 as described above, the controller 10 and the external terminal 22 may communicate with each other.

In this case, the controller 10 transmits the tuning detection code and the stored learning value to the external terminal 22, and thus the external terminal 22 may store the tuning detection code and the learning value of the vehicle, and thus may collect data associated with the vehicle (S16).

As a result, because the tuning detection code and the learning value are stored and remain in the controller 10 even after the driver detaches the external tuning chip which has been illegally mounted before the external terminal 22 is connected with the vehicle, it is possible to know, through the external terminal 22, whether the vehicle may have been tuned.

As described above, because the automobile manufacturer may know whether the tuning chip is mounted and used by the driver, the driver cannot conceal that the tuning chip has been previously used, and therefore, it is possible not only to induce the driver to detach the tuning chip by himself/herself, but also to induce the driver not to mount the tuning chip from the beginning.

Because it is possible to prevent damage to the engine and the incurrence of repairing costs caused by illegal tuning by the driver, and the automobile manufacturer may clarify who takes responsibility for damage to the engine, it is possible to solve a problem that the automobile manufacture bears the responsibility for the illegal tuning.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “interior”, “exterior”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of detecting tuning of a vehicle, the method comprising:
obtaining and storing, by a controller, at least one of learning information including a variable value and a control value and engine state information at a time of controlling the vehicle while the vehicle is driven, as a learning value;
comparing, by the controller, a learning value, which is newly obtained over time, with a prestored previous learning value;
determining, by the controller, that a tuning chip for changing component performance in the vehicle is mounted when the learning value is changed and there remains a difference between the obtained learning value and the prestored previous learning value at a predetermined level or higher for a predetermined period of time; and
creating and storing, by the controller, a tuning detection code when it is determined that the tuning chip is mounted.

2. The method of claim 1, wherein the variable value and the control value are a variable value and a control value at a time of controlling a turbocharger and an engine in a turbocharged vehicle, and the tuning chip for changing component performance in the vehicle is a tuning chip for increasing engine output.

3. The method of claim 1, wherein the variable value is one or both of a signal value of a manifold absolute pressure (MAP) sensor and a signal value of a boost pressure sensor that are obtained together with signal values of an Accel Position Sensor (APS) for detecting a position of an accelerator pedal.

4. The method of claim 3, wherein the controller compares the signal value of the MAP sensor and the signal value of the boost pressure sensor, which are newly obtained as a learning value, with the previous signal value which is a learning value when the signal values of the APS are the same, and determines that the tuning chip is mounted when there remains a difference at a predetermined level or higher for a predetermined period of time.

5. The method of claim 1, wherein the control value is boost pressure at a time of controlling a turbocharger.

6. The method of claim 1, wherein the control value is an amount of fuel injected into an engine which is obtained together with signal values of an Accel Position Sensor (APS), and the controller compares an amount of fuel, which is newly obtained as a learning value, with a previous amount of fuel which is a learning value when the signal values of the APS are the same, and determines that the tuning chip is mounted when there remains a difference at a predetermined level or higher for a predetermined period of time.

7. The method of claim 1, wherein the engine state information is engine knock occurrence information, that is, knock intensity or knock occurrence frequency.

8. The method of claim 7, wherein the controller determines that the tuning chip is mounted when misfire occurs in all cylinders of an engine or when misfire occurrence frequency for a predetermined time is increased to a predetermined level or higher compared to a previous misfire occurrence frequency.

9. The method of claim 2, wherein when it is determined that the tuning chip is mounted, the controller restricts engine torque so that the engine torque is predetermined torque or lower.

10. The method of claim 1, wherein the controller is configured to transmit the tuning detection code to an external terminal when the external terminal is communicatively connected in a state in which the tuning detection code is stored.

11. The method of claim 10, wherein the controller is configured to transmit data of the learning value that is obtained and stored to the external terminal.
